(19) United States
(12) Patent Application Publication
(10) Pub. No.: US 2020/0010304 A1
(43) Pub. Date: Jan. 9, 2020

(54) Safety Device for Elevator for Protecting Hand from Getting Jammed

(71) Applicant: Il Shik YOON, Seoul (KR)

(72) Inventor: Il Shik YOON, Seoul (KR)

(21) Appl. No.: 16/341,276

(22) PCT Filed: May 24, 2017
(86) PCT No.: PCT/KR2017/005371

§ 371 Date: Apr. 11, 2019

(30) Foreign Application Priority Data
Mar. 28, 2017 (KR) 10-2017-0039035

(51) Int. Cl. B66B 13/24

(52) U.S. Cl. CPC B66B 13/245

(57) ABSTRACT

The present invention relates to a safety device for preventing a hand from being caught by controlling an operation of opening/closing a door while reducing impact when a person's hand is jammed in a gap between an elevator door and a doorframe.

### FIELD OF THE INVENTIONS

The present invention relates to a safety device of an elevator for protecting a hand from being caught, and particularly, to a safety device for protecting a hand from being caught by controlling an operation of opening and closing of a door while reducing impact when a person's hand is caught in a gap between an elevator door and a doorframe.

### BACKGROUND OF THE INVENTIONS

A gap is provided between a door D and a doorframe 10 to allow an elevator door D to be smoothly opened or closed. However, when a passenger waits for an elevator car at a platform to get in the elevator car while touching a door surface with his/her hand, an accident often occurs in which the passenger's hand is caught in the gap between the doorframe and the door and thus getting injured in the state when the passenger hand is on the door surface without noticing that the door D is being opened. In particular, children often experience this safety accident when their hands are caught in the gap because of a lack of attention.

According to the statistical data published on Feb. 19, 2016 by the Korea Ministry of Public Safety and Security, a total of 319 safety accidents occurred over the last 10 years, causing 365 casualties, of which 91 were killed. A major accident, among the accidents in which the hand is caught, requires a treatment over three weeks or more and occurs about once a year, and the number of minor accidents reported to the Korea Consumer Protection Board reached 79 in 2013, 103 in 2014, and 92 in 2015. To prevent the accident, Korean regulations related to the elevator become stricter so that the reference of the gap between the elevator door and the doorframe is decreased to 5 mm from the previous reference of 10 mm.

To solve such a problem, FIG. 1 illustrates a device in the related art, in which FIG. 1A illustrates a state immediately before a hand is caught, and FIG. 1B illustrates a state after the hand is caught.

As illustrated in FIGS. 1A and 1B, in the device 12 in the related art, when a finger collides with a shock absorbing material at a side of an elevator door in a state in which the elevator door is being opened in a direction of arrow A, a detection unit is moved in a direction of arrow B and a switch is actuated, such that the operation of the elevator door is stopped.

In the case of the device in the related art, there is concern that the finger will be injured while colliding with the shock absorbing material when the door is being opened, as illustrated in FIG. 1A, even though the shock absorbing material absorbs impact, and there is also concern that the finger will be bent because the finger is caught and pressed between the detection unit and the door, as illustrated in FIG. 1B.

In addition, the elevator door D is deformed as time passed or because the elevator door D is not very precisely installed. FIG. 2 is a side view illustrating an example in which the elevator door is deformed. As illustrated, the elevator door D is bent as a long period of time has elapsed or because the elevator door is not accurately installed, and as a result, there is a problem in that a gap in a middle section between the door and the doorframe 10 is gradually increased. In particular, even though the passenger's hand may easily access the middle section, the device 12 in the related art has no function of adjusting the gap and thus cannot prevent an accident that the passenger's hand is caught in the gap in the middle section which has been increased from the initial gap.

In addition, there is a problem in that the device in the related art sags downward due to its own weight as time passed after the installation of the device and thus comes into contact with a floor, which causes friction.

In addition, there is a problem in that an operator is exposed to a dangerous environment because the installation and the maintenance of the device in the related art need to be performed in an elevator shaft.

### SUMMARY

An object of the present invention is to prevent an injury to a finger by rotating a part with which the finger comes into contact when the finger is caught, and to assuredly prevent a finger-caught accident by adjusting a gap between a door and a doorframe even in a case in which the gap between the door and the doorframe is increased from a reference gap due to deformation of the elevator door.

Another object of the present invention is to prevent friction between an elevator and a floor by preventing the elevator from sagging even though the elevator is used over a long period of time, and to ensure safety of an operator by enabling the operator to perform, in a hallway instead of in an elevator shaft, operations of installing, disassembling, and maintaining the elevator.

### Technical Solution

To achieve the objects, the present invention provides a safety device of an elevator for preventing a hand from being caught, the safety device including: a stationary frame 20 which has a cross section having a u-shape and is installed along an overall length of a stepped portion of the doorframe 10 between a doorframe 10 of an elevator door and a hall door D of the elevator; a plate-shaped rotating frame 30 which is rotatably installed at one end portion of the stationary frame 20; an operating pin 40 which is installed on the stationary frame 20 to support a rear surface of the rotating frame 30, supported by a spiral spring S, pushed toward the inside of the stationary frame 20 by a rotation of the rotating frame 30, and protrudes to the outside of the stationary frame 20 by elastic force of the spiral spring S; a switch 50 which is installed in the stationary frame 20 such that the switch 50 is actuated when the operating pin 40 is pushed toward the inside of the stationary frame 20 by the rotation of the rotating frame 30; and a controller C which is connected to the switch 50 and stops an operation of the elevator hall door D or controls an opening/closing speed of the elevator hall door D when the switch 50 is actuated, the controller C controlling operations of the elevator and the door, in which multiple oblong holes 22 elongated horizontally are formed at predetermined intervals in a part of the stationary frame 20 which is in contact with the doorframe 10, such that the stationary frame 20 is fixed to the doorframe 10 by fasteners such as screws or bolts through the oblong holes 22 while adjusting a gap between an end portion of the rotating frame 30 and the hall door D when the rotating frame 30 is maximally opened, and the rotating frame 30 is rotated and the switch 50 is actuated to stop the operation of the elevator hall door D or control an opening/closing speed of the elevator hall door D when a person's hand is caught in the gap, such that the person's hand is prevented from being put into the gap.

In the device according to the present invention, the rotating frame 30 may be rotated in a hinged manner.

In addition, the device according to the present invention may further include a finishing cover 25 which closes an opening portion of the stationary frame 20, in which the finishing cover 25 covers the gap between the stationary frame 20 and the doorframe 10.

### Advantageous Effects

According to the safety device according to the present invention as configured as described above, it is possible to prevent an injury to a finger by rotating the part with which the finger comes into contact when the finger is caught, and it is possible to assuredly prevent a finger-caught accident by adjusting the gap between the door and the doorframe even in a case in which the gap between the door and the doorframe is increased from a reference gap due to deformation of the elevator door.

According to the present invention, it is possible to prevent damage to the device by preventing operating parts from coming into contact with the floor even though the device is used over a long period of time, and it is possible to achieve safety of an operator by enabling the operator to perform, in the hallway instead of in the elevator shaft, the operations of installing, disassembling, and maintaining the elevator.

### BRIEF DESCRIPTION OF THE DRAWINGS

FIG. 1 is a cross-sectional view of an example of a device for preventing a hand from being caught in the related art.

FIG. 2 is a side view illustrating an example in which a gap between an elevator door and a doorframe is changed.

FIG. 3 is a top plan view illustrating an example of a device according to the present invention.

FIG. 4 is a perspective view of the device according to the present invention in FIG. 3.

FIGS. 5 to 8 are various views illustrating differences between the device in the related art and the device according to the present invention.

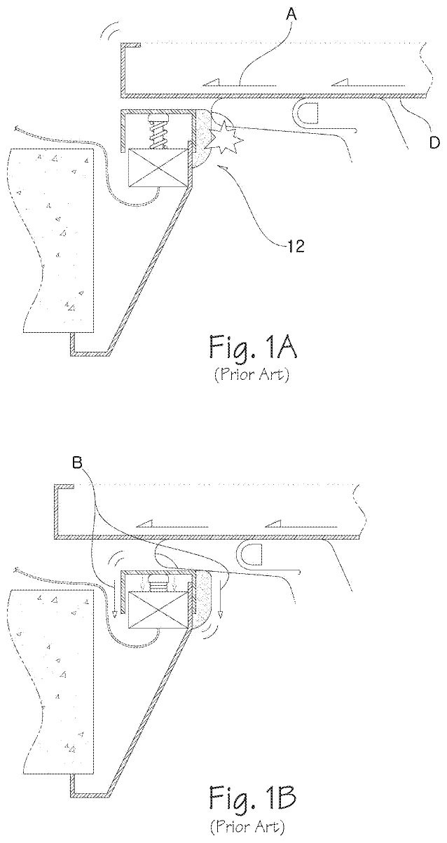

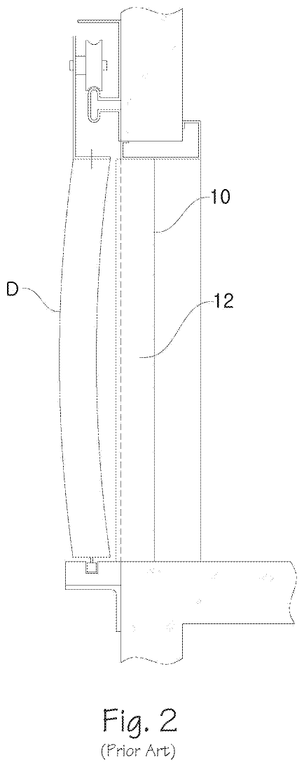

### DETAILED DESCRIPTION OF THE INVENTIONS

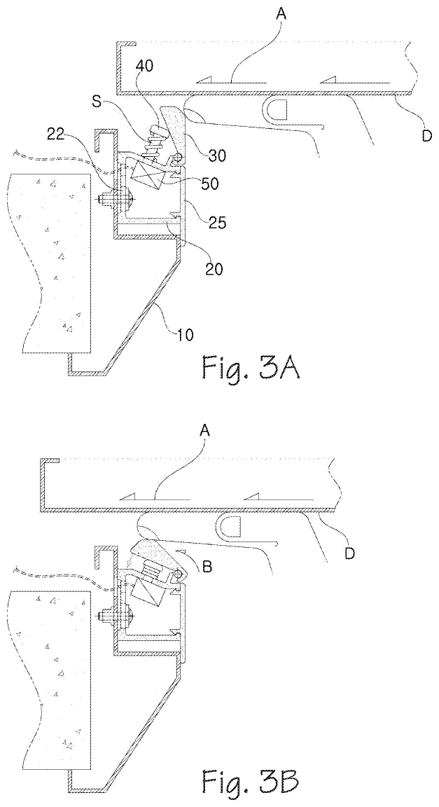

FIG. 3 is a top plan view illustrating an example of the present invention, in which FIG. 3A illustrates a state immediately before a finger is caught, and FIG. 3B illustrates a state after the finger is caught.

A doorframe 10 has an inwardly concave stepped portion between the doorframe 10 of an elevator door and a hall door D of an elevator. A stationary frame 20, which has a cross section having a u-shape, is installed along an overall length of the stepped portion. In this case, the stationary frame 20 is fixed to the doorframe by fasteners such as screws or bolts through multiple oblong holes 22 formed at one side of the stationary frame 20.

A plate-shaped rotating frame 30 is rotatably installed at one end portion of the stationary frame 20, specifically, at one end portion opposite to the doorframe, and the rotating frame 30 may be installed to be rotatable in a general hinged manner. The rotating frame 30 may be made of any material including metal. Meanwhile, as necessary, a soft elastic material may be attached to a surface of the rotating frame 30 in order to prevent an injury to a finger that collides with the rotating frame 30. In addition, the rotating frame 30 may have a shape, specifically, a wedge shape that allows an operating pin 40 installed at a rear side to smoothly operate.

The operating pin 40 is installed on the stationary frame 20 to support a rear surface of the rotating frame 30, and the operating pin 40 is supported by a spiral spring S. The operating pin 40 is pushed toward the inside of the stationary frame 20 by the rotation of the rotating frame 30, and moves and protrudes to the outside of the stationary frame 20 by elastic force of the spiral spring S. As illustrated, a portion of the stationary frame 20 on which the operating pin 40 is installed may be inclined at a predetermined angle with respect to a lateral side.

A switch 50 is installed in the stationary frame 20 such that the switch 50 is actuated when the operating pin 40 is pushed toward the inside of the stationary frame 20 by the rotation of the rotating frame 30. For example, any type of switch may be used as long as the switch may be connected when the operating pin 40 is pushed inward.

A controller C is connected to the switch 50, and the controller C stops an operation of an elevator hall door D or controls an opening/closing speed of the elevator hall door D when the switch 50 is actuated.

In addition, a finishing cover 25 is installed in an opening portion of the stationary frame 20 to cover the inside of the stationary frame. The stationary frame 20 according to the present invention is disposed to be spaced apart from the doorframe 10 at an interval so as to be movable relative to the door in order to adjust a gap between the door and the stationary frame 20. In this case, the finishing cover 25 may have a structure that covers the gap between the stationary frame 20 and the doorframe 10 (see FIG. 3).

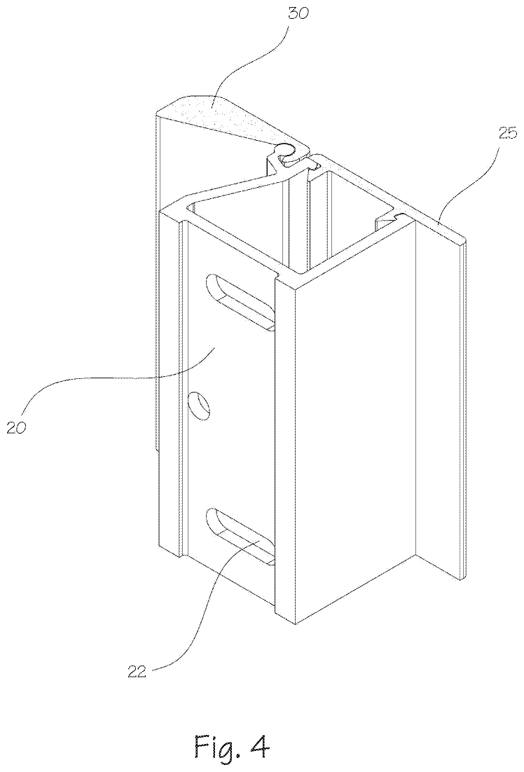

FIG. 4 is a perspective view illustrating well a structure of the device according to the present invention.

As illustrated, multiple elongated oblong holes 22 are horizontally formed at predetermined intervals in the portion of the stationary frame 20 to which the doorframe 10 is coupled, and the stationary frame may be fixed to the doorframe by using fasteners through the oblong holes. Since the oblong hole 22 has a horizontally elongated shape, the stationary frame 22 may be fixed while being moved to have an appropriate gap with the hall door D.

An operating process of the present invention configured as described above will be described.

As illustrated in FIG. 3A, a person's finger comes into contact with the rotating frame 30 along the hall door D that moves in the direction of arrow A in a state in which the rotating frame 30 stands upright by the spring S and the operating pin 40.

In this case, the operating pin 40 is pushed inward as the rotating frame 30 is rotated in the direction of arrow B by pressure of the finger, and the controller C stops the operation of the elevator hall door D or controls the opening/closing speed of the elevator hall door D when the switch 50 is connected, thereby preventing the person's hand from being further pushed inward (see FIG. 3B).

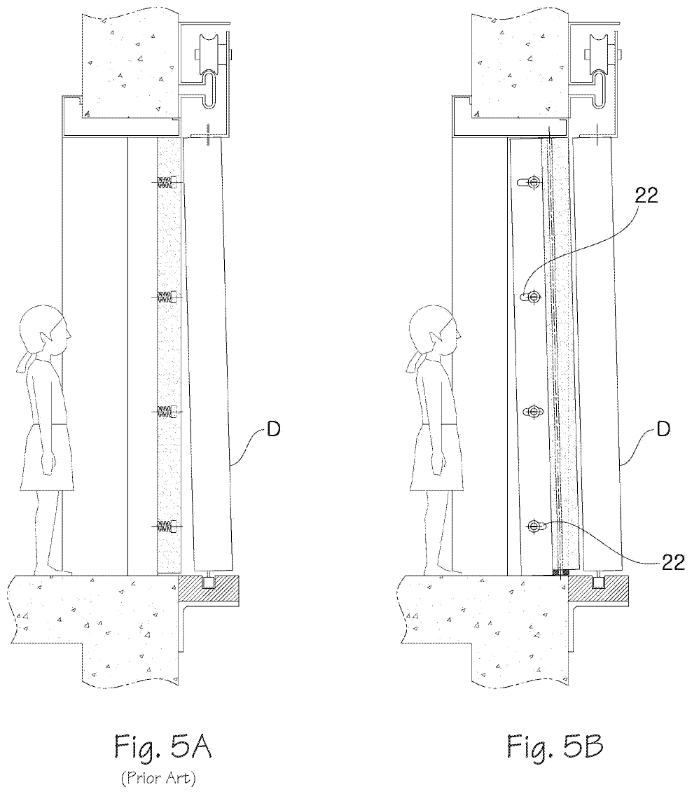

FIG. 5 is a side view illustrating a difference between a device in the related art and the device according to the present invention when the gap between the door D and the doorframe 10 is changed.

As an example in the related art, FIG. 5A illustrates a state in which the gap between the elevator hall door D and the doorframe is further increased toward the lower side. However, the device in the related art has no function of adjusting the gap in accordance with the change in gap even in the state in which the gap is further increased.

In contrast, referring to the example according to the present invention in FIG. 5B, it can be seen that since the oblong hole 22 elongated horizontally is used, the device according to the present invention may be fixed by adjusting the gap to the extent of the length of the oblong hole 22. Here, it can be seen that the gap between the door D and the doorframe may be always maintained constantly by tightening the fastener toward the inside of the oblong hole toward the lower side. For this reason, it is possible to thoroughly prevent the accident if the person's hand is caught in the doorframe.

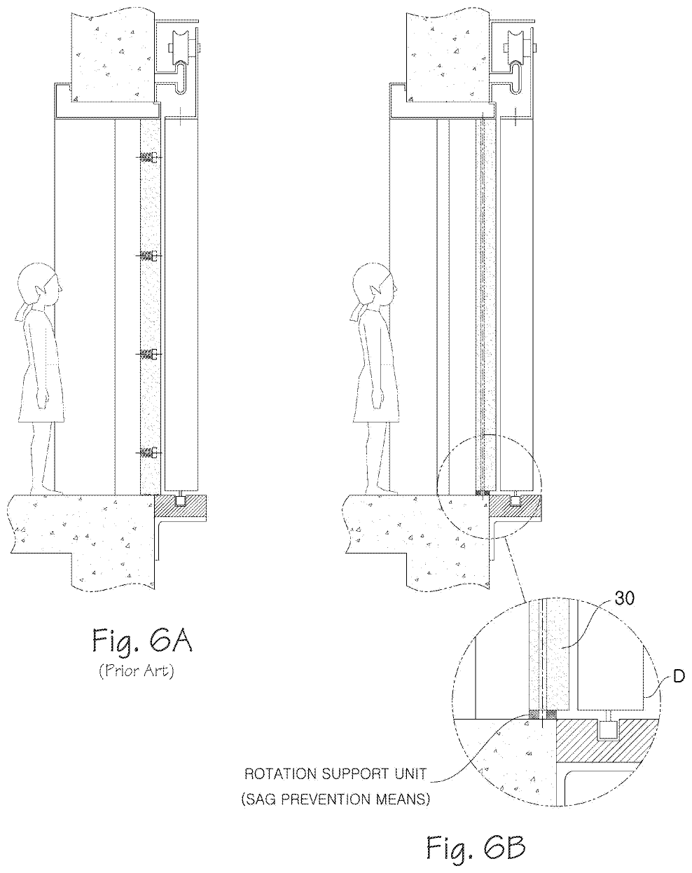

FIG. 6 is a side view illustrating a state in which the device in the related art sags downward due to its own weight as time passes, and illustrating an advantage of the present invention that solves this problem.

As illustrated in FIG. 6A, in the case of the device in the related art, the fastener is bent by the weight of the device as time passes, as illustrated in the enlarged view, and as a result, operating parts come into contact with the floor surface, which causes a problem of friction.

In contrast, in the case of the device according to the present invention illustrated in FIG. 6B, a rotating shaft of the rotating frame 30 is maintained in a vertical state only by a rotation support unit installed as a sag prevention means, as illustrated in the enlarged view, and as a result, the rotating frame 30, which is the operating part, does not come into contact with the floor even though a long period of time has elapsed, such that there occurs no problem such as in the related art.

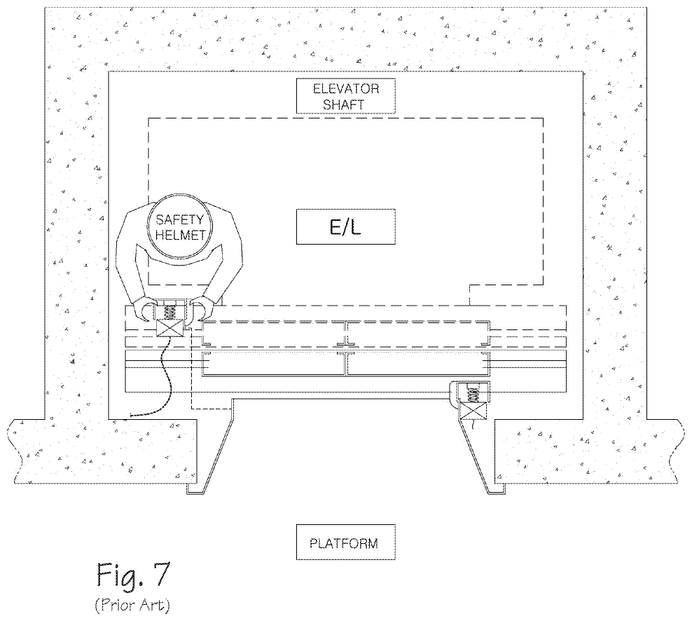

FIG. 7 is a top plan view illustrating the work for installing the device in the related art, and as illustrated, an operator needs to perform, in an elevator shaft, the work for installing and maintaining the elevator. Therefore, the operator is always exposed to an environment where there is a risk of a fall, and as a result, a separate countermeasure is required to ensure safety.

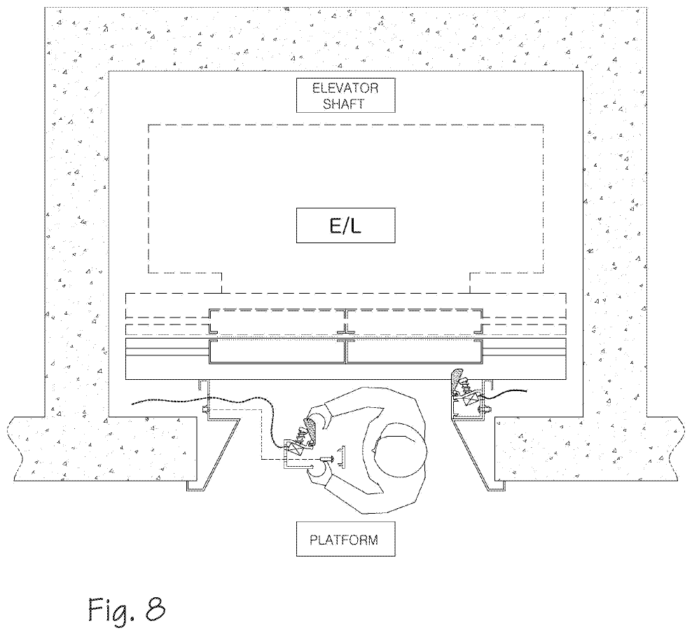

FIG. 8 is a top plan view illustrating the work for installing the device according to the present invention, and as illustrated, the operator may perform the work in a hallway in front of the door instead of in the elevator shaft, thereby always ensuring safety of the operator.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

1. A safety device of an elevator for preventing a hand from being caught, the safety device including:
a stationary frame 20 which has a cross section having a u-shape and is installed along an overall length of a stepped portion of the doorframe 10 between a doorframe 10 of an elevator door and a hall door D of the elevator;
a plate-shaped rotating frame 30 which is rotatably installed at one end portion of the stationary frame 20;
an operating pin 40 which is installed on the stationary frame 20 to support a rear surface of the rotating frame 30, supported by a spiral spring S, pushed toward the inside of the stationary frame 20 by a rotation of the rotating frame 30, and protrudes to the outside of the stationary frame 20 by elastic force of the spiral spring S;
a switch 50 which is installed in the stationary frame 20 such that the switch 50 is actuated when the operating pin 40 is pushed toward the inside of the stationary frame 20 by the rotation of the rotating frame 30; and
a controller C which is connected to the switch 50 and stops an operation of the elevator hall door D or controls an opening/closing speed of the elevator hall door D when the switch 50 is actuated, the controller C controlling operations of the elevator and the door,
wherein multiple oblong holes 22 elongated horizontally are formed at predetermined intervals in a part of the stationary frame 20 which is in contact with the doorframe 10, such that the stationary frame 20 is fixed to the doorframe 10 by fasteners such as screws or bolts through the oblong holes 22 while adjusting a gap between an end portion of the rotating frame 30 and the hall door D when the rotating frame 30 is maximally opened, and
the rotating frame 30 is rotated and the switch 50 is actuated to stop the operation of the elevator hall door D or control an opening/closing speed of the elevator hall door D when a person's hand is caught in the gap, such that the person's hand is prevented from being put into the gap.

2. The safety device of claim 1, wherein the rotating frame 30 is rotated in a hinged manner.

3. The safety device of claim 1, further comprising:
a finishing cover 25 which closes an opening portion of the stationary frame 20, wherein the finishing cover 25 covers the gap between the stationary frame 20 and the doorframe 10.

4. The safety device of claim 2 further comprising:
a finishing cover 25 which closes an opening portion of the stationary frame 20, wherein the finishing cover 25 covers the gap between the stationary frame 20 and the doorframe 10.
